(19) United States
(12) Patent Application Publication
(10) Pub. No.: US 2007/0260638 A1
(43) Pub. Date: Nov. 8, 2007

(54) Commands for the handling of large files

(75) Inventors: Jens Ole Madsen, Frederiksberg C (DK); Peter Vestergaard, Humlebaek (DK); Rune Lindholm, Sottunga (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/416,420

(22) Filed: May 2, 2006

(51) Int. Cl. G06F 17/00

(52) U.S. Cl. 707/104.1

(57) ABSTRACT

A system for permitting the flexible handling of large amounts of structured data in files on smart cards and similar data storage units. The present invention introduces a new type of command which extracts relevant portions of structured information that is stored in files on smart cards and similar data units, instead of reading the complete data set and parsing it in the terminal. The present invention can also be applied to other, non-card storage media.

### FIELD OF THE INVENTION

The present invention relates generally to universal integrated circuit cards (UICCs). More particularly, the present invention relates to the accessing and use of large files within UICCs.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The European Telecommunications Standards Institute (ETSI) specification ETSI TS 102 221 describes the electrical and physical characteristics of UICCs, including their basic file structure and basic commands for file handling. The details of the files and specialized commands are described in specifications for individual applications on cards such as subscriber identity module (SIM), universal SIM (USIM), IP Multimedia SIM (ISIM) and removable user identity module (R-UIM) cards.

Different types of files can exist on a card at issue. There are generally two primary types of files. Binary elementary files imply disordered data files, and linear fixed files (or record-based files), consist of a number of fixed-length records. FIG. 1 shows the structure of a binary file, while FIG. 2 shows the structure of a record based file. In binary files, data are addressed by byte-numbers. In record based files, data are addressed by record number. For technical reasons, binary files are limited in size to 32 kbytes, while record-based files are limited to a maximum of 254 records, with each record having a maximum of 255 bytes.

In addition to the above, a new type of file, BER-TLV structure elementary files, was recently introduced. In BER-TLV structure elementary files, there is no upper limit on the size of these files. For this reason, they are sometimes also referred to as “large files”), and data is stored in tag-length-value (TLV) structures. The structure of a BER-TLV file is depicted in FIG. 3. Each tag is unique within the file.

Specific commands have been defined for reading from and writing to BER-TLV files. The RETRIEVE DATA command is used to read the value of a TLV identified by its tag. The SET data command is used to write the value of a TLV (either writing a new TLV or updating an existing TLV) identified by its tag.

To date, the only use of large files has been for multimedia message storage. However, this type of file is also suitable for generic data storage. For example, large files could be used for an improved USIM phonebook, where entries could be stored as electronic personal data cards, commonly known as vCards, encoded within TLVs. Other possibilities include the potential storage of generic XML data in large files.

The existing USIM phonebook is based on a construction with many record-based files, each containing a different piece of information (one file with records containing name and number, one file with records containing e-mail, etc), which is quite complex and difficult to extend with new types of information.

Despite such possibilities for improvements, however, there are currently a number of issues which prevent such possibilities from becoming realities. In the case of a USIM phonebook, for example, it is likely that an improved USIM phonebook would be stored in large files, for example in vCard format. During terminal start-up, it is important to read the phonebook from the UICC as quickly as possible. However, in order to start up the terminal, it is not necessary to read the entire content of the phonebook; it would be enough to simply read all of the names and primary telephone numbers. This information can be used to make a list of entries which can be shown to the user, and additional details can then be read from the card at a later time upon request of the user. Currently, however, such a process is not technically possible, as there are no commands that allow the terminal to read only a portion of a TLV from the card. Therefore, if an improved USIM phonebook was based on storage of vCards in a large file, in order to construct a list of content, the terminal would be forced to read the complete file from the card, resulting in delays in the start-up sequence.

### SUMMARY OF THE INVENTION

The present invention addresses the issues described above by defining a new command which allows a terminal to request a portion of a TLV, based on a well-defined sub-division of the individual TLVs. This command can also be used to request a list of sub-elements from all TLVs in a file. In the case of a phonebook, for example, such a command allows a terminal to request the “name” portion of a certain TLV, or to request a list of all names in the whole file.

The present invention provides for a number of distinct advantages over conventional systems. With the present invention, a terminal is capable of reading relevant information from a large file, without having to read the entire file. This allows for a more efficient use of data on the card and reduces the load imposed on the interface between the terminal and UICC. This also increases the effective bandwidth and diminishes the load on the terminal's battery.

Another advantage of the present invention is that it opens the door for further improvements in USIM phonebooks, and also opens the door for further improvements in potential data storage on UICCs.

Although examples discussed herein focus specifically to the BER-TLV structure files on a UICC, the present invention can also be implemented with regard to other forms of mass storage, such as MMC cards or USB mass storage devices.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of binary elementary file;

FIG. 2 is a representation of a record based file;

FIG. 3 is a representation of a BER-TLV structure file; and

FIG. 4 is a schematic representation of circuitry that can appear in an electronic device involved in the implementation of the present invention

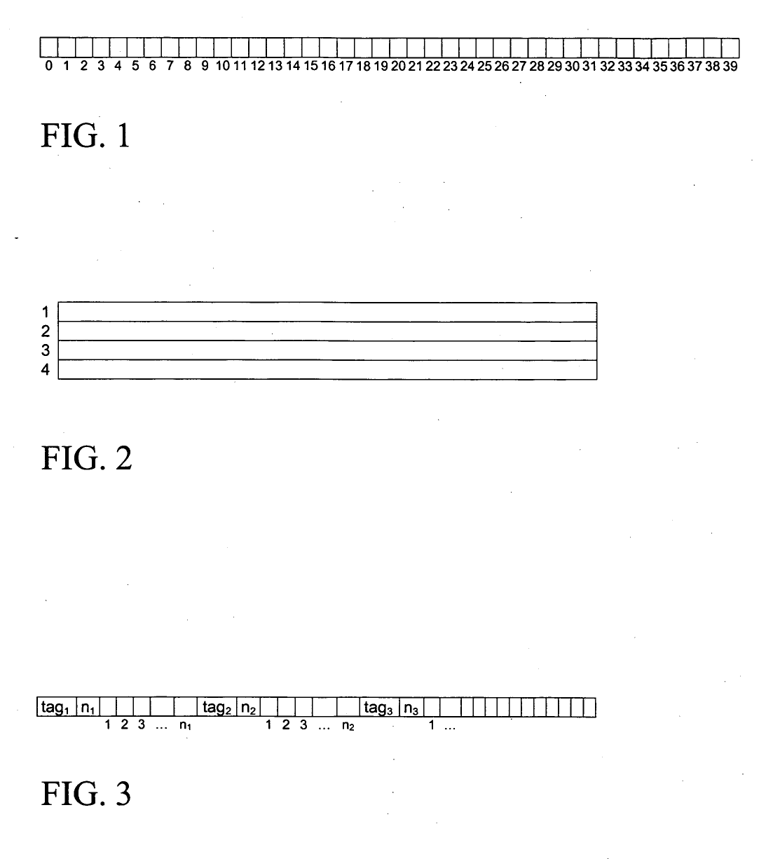

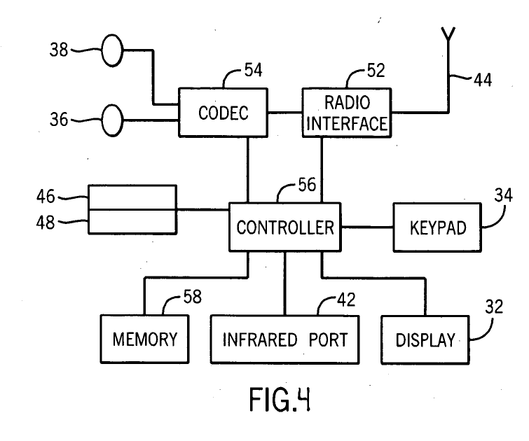

### DETAILED DESCRIPTION OF PREFERRED EMBODIMENTS

The present invention addresses the issues described above by defining a new command which allows a terminal to request a portion of a TLV, based on a well-defined sub-division of the individual TLVs. This command can also be used to request a list of sub-elements from all TLVs in a file. In the case of a phonebook, for example, such a command allows a terminal to request the “name” portion of a certain TLV, or to request a list of all names in the whole file.

For the implementation of the present invention, one issue deals with how to distinguish between the individual elements within a TLV. One option for addressing this issue is to define the commands in a flexible way which allows for different schemes to be used in different files. The particular form to use can be communicated via the command parameters. In addition, it is also possible to choose one single scheme which is always used, although this option is less flexible in nature.

The format in schematic form for a command to be used is as follows: RETRIEVE DATA (scheme; entry, element, offset, length)

An explanation of the various parameters is presented below. While all of these parameters may be useful in different situations, all of the parameters may not be needed in certain implementations.
Scheme: identifies the scheme which is used to identify individual elements within the entry. Examples are TLV, XML, vCard, etc.
Entry: identifies the file entry. Possible values include: <tag>; next; previous; first; last; <number>, all, where <tag> is the unique tag of the entry and <number> is the number of the entry.
Element: identifies the relevant element in the entry, e.g. “name” or “telephone number” if the entry is an entry in a telephone directory.
Offset: offset from the start of the content.
Length: number of characters to read.

A response to the command comprises a list of the element content. The “tag” is the identifier for the TLV requested, and the “element” identifies which part of the TLV is requested. It should be noted that the element does not have to be unique within the TLV. If the terminal requests the phone-number element within a TLV, then the terminal will receive a list of all the phone numbers in the relevant TLV.

An entry in a BER-TLV structure is a TLV, i.e., it has the form Tag, Length, Value, where Tag is a unique identifier, Length is the length of the value part, and Value is the data portion of the object.

As an example of a phonebook entry, a vCard is depicted below:
BEGIN:vCard
VERSION:3.0
FN:Frank Lawson
ADR;TYPE=WORK,POSTAL,PARCEL:;;6544 Battleford Drive;Raleigh;N.C.;27613-3502;U.S.A.
TEL;TYPE=VOICE,MSG,WORK:+1-919-676-9515
END:vCard

The following are three mechanisms that can be used in the implementation of the present invention. It should be noted that the following mechanisms are only exemplary in nature, and the present invention is not intended to be limited to these mechanisms.

A first alternative for implementing the present invention involves having elements within TLVs being structured as TLVs. In the phonebook example discussed previously, a standardized set of tags can be used. Such tags can comprise, for example:

| Type | Tag |
|---|---|
| VERSION | ‘80’ |
| FN (Formatted Name) | ‘81’ |
| ADR (Address) | ‘82’ |
| TEL (Telephone) | ‘83’ |
| . . . | . . . |

Taking the tag value to be ‘BF 81 00’ as an example, the phonebook entry discussed above is:
BF 81 00
7E
80 03 ‘3.0’
81 0C ‘Frank Lawson’
82 4C ‘TYPE=WORK,POSTAL,PARCEL:;;6544 Battleford Drive;Raleigh;N.C.;27613-3502;U.S.A.’
83 23 ‘TYPE=VOICE,MSG,WORK:+1-919-676-9515’

It should be noted that a binary encoding could also be used to compress, e.g., TYPE=WORK,POSTAL,PARCEL.

If the approach described above is used, the command for obtaining the name is in the form RETRIEVE DATA (Tag=BF 81 00, “subtag” 81), and the response is ‘Frank Lawson’.

In a second alternative, elements within TLVs are formatted as XML documents. XML document sub-parts are distinguished by the format: “begin-tag; value; end-tag”; for example <FN>Frank Lawson<\FN>. Using this type of format, the phonebook entry is as follows:
BF 81 00

B0

<VERSION>3.0<\VERSION>
<FN>Frank Lawson<\FN>
<ADR>TYPE=WORK,POSTAL,PARCEL:;;6544 Battleford
Drive;Raleigh;NC;27613-3502;U.S.A.<\ADR>
<TEL>TYPE=VOICE,MSG,WORK:+1-919-676-9515<\TEL>

As in the first option discussed previously, there are many possibilities for compression in this technique.

Assuming XML format, RETRIEVE DATA command takes the form: RETRIEVE DATA (Tag−BF 81 00, xml-tag ‘FN’)

The UICC then returns the value (or the values, if there are more than one) between <FN> and <\FN>.

In a third alternative, the vCard format is used directly within the TLV's. In this system, the start of an individual element is defined by a keyword (e.g., FN), and the end of an individual element is defined by the start of the keyword for the next element. This system is somewhat less flexible than the other systems discussed herein, as it requires the UICC to have a complete list of possible keywords in order to be able to distinguish between elements; on the other hand, this system makes the implementation of a large-file phonebook very simple.

The following is one example, where it is assumed that there is a phonebook entry stored in a file (this is not necessarily the actual format which is stored in the file, but only serves as an example to illustrate the working of these commands):
myTag
Length
BEGIN:vCard
VERSION:3.0
FN:Frank Lawson
ADR;TYPE=WORK,POSTAL,PARCEL:;;6544 Battleford Drive;Raleigh;N.C.;27613-3502;U.S.A.
TEL;TYPE=VOICE,MSG,WORK:+1-919-676-9515
END:vCard

It should be noted that the Length is shown above as 81 A6. This is because when the length is between 127 and 255 bytes, it is coded on two bytes. The first byte has a constant hexadecimal value ‘81’, while the second byte is the actual length in hexadecimal.

In this case, the command is RETRIEVE DATA (myTag, FN), and the response is the string “Frank Lawson”. The command RETRIEVE DATA (all tags, FN) gives back a list of all FN elements in the file: (tag1, name1, tag2, name2, . . . , myTag, “Frank Lawson”, . . . ). In one embodiment, this list has to be sent using more than one response message.

The detailed implementation of the present invention on a UICC, although not described in detail herein, would be well understood by those skilled in the art. The implementation in the UICC may be performed, for example, using a lookup table with keywords, it can be performed by reading and parsing the data in the file when the data is requested, or a combination of these two methods could be used. In addition to the above, it should also be noted that similar commands to those discussed above can also be defined for writing parts of a TLV to the file.

FIG. 4 shows the circuitry that can appear in one representative electronic device within which different aspects of the present invention may be implemented. It should be understood, however, that the present invention is not intended to be limited to one particular type of electronic device. The electronic device of FIG. 4 includes a display 32, a keypad 34, a microphone 36, an ear-piece 38, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones. The present invention is also applicable to fixed devices such as personal computers.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of handling structured data in files contained on a data storage unit, comprising:
receiving a request for a content item, the content item being stored in a portion of a TLV structure of a BER-TLV structure elementary file;
inputting a RETRIEVE DATA command, the RETRIEVE DATA command identifying the portion of the TLV structure which includes the content item; and
in response to the RETRIEVE DATA command, receiving the content item from the data storage unit.

2. The method of claim 1, wherein the RETRIEVE DATA command includes a subtag value specific to a category of information within which the content item falls.

3. The method of claim 1, wherein the RETRIEVE DATA command includes an XML-tag item, the XML-tag item used to identify a category of information within which the content item falls.

4. The method of claim 1, wherein the RETRIEVE DATA command includes a keyword, the keyword used to identify a category of information within which the content item falls.

5. The method of claim 1, wherein the RETRIEVE DATA command includes a tag identifying the specific TLV structure which includes the content item.

6. The method of claim 1, wherein the received request includes a request for all content items falling within a specific category on the BER-TLV structure elementary file, wherein the RETRIEVE DATA command includes an indication that all content items falling within the specific category are desired, and wherein all content items falling within the specific category are returned in response to the RETRIEVE DATA command.

7. The method of claim 1, wherein the storage unit is selected from the group consisting of a UICC, a SIM card, a USIM card, an ISIM card, and a R-UIM card.

8. The method of claim 1, wherein the content item comprises a portion of an individual's contact information.

9. The method of claim 1, wherein the TLV structure includes data in vCard format.

10. A computer program product, embodied in a computer-readable medium, for handling structured data in files contained on a data storage unit, comprising:
computer code for receiving a request for a content item, the content item being stored in a portion of a TLV structure of a BER-TLV structure elementary file;
computer code for inputting a RETRIEVE DATA command, the RETRIEVE DATA command identifying the portion of the TLV structure which includes the content item; and
computer code for, in response to the RETRIEVE DATA command, receiving the content item from the data storage unit.

11. The computer program product of claim 10, wherein the RETRIEVE DATA command includes a subtag value specific to a category of information within which the content item falls.

12. The computer program product of claim 10, wherein the RETRIEVE DATA command includes an XML-tag item, the XML-tag item used to identify a category of information within which the content item falls.

13. The computer program product of claim 10, wherein the RETRIEVE DATA command includes a keyword, the keyword used to identify a category of information within which the content item falls.

14. The computer program product of claim 10, wherein the RETRIEVE DATA command includes a tag identifying the specific TLV structure which includes the content item.

15. The computer program product of claim 10, wherein the received request includes a request for all content items falling within a specific category on the BER-TLV structure elementary file, wherein the RETRIEVE DATA command includes an indication that all content items falling within the specific category are desired, and wherein all content items falling within the specific category are returned in response to the RETRIEVE DATA command.

16. The computer program product of claim 10, wherein the TLV structure includes data in vCard format.

17. An electronic device, comprising:
a processor; and
a memory unit communicatively connected to the processor and including:
computer code for receiving a request for a content item, the content item being stored in a portion of a TLV structure of a BER-TLV structure elementary file;
computer code for inputting a RETRIEVE DATA command, the RETRIEVE DATA command identifying the portion of the TLV structure which includes the content item; and
computer code for, in response to the RETRIEVE DATA command, receiving the content item from the data storage unit.

18. The electronic device of claim 17, wherein the RETRIEVE DATA command includes a subtag value specific to a category of information within which the content item falls.

19. The electronic device of claim 17, wherein the RETRIEVE DATA command includes an XML-tag item, the XML-tag item used to identify a category of information within which the content item falls.

20. The electronic device of claim 17, wherein the RETRIEVE DATA command includes a keyword, the keyword used to identify a category of information within which the content item falls.

21. The electronic device of claim 17, wherein the RETRIEVE DATA command includes a tag identifying the specific TLV structure which includes the content item.

22. The electronic device of claim 17, wherein the received request includes a request for all content items falling within a specific category on the BER-TLV structure elementary file, wherein the RETRIEVE DATA command includes an indication that all content items falling within the specific category are desired, and wherein all content items falling within the specific category are returned in response to the RETRIEVE DATA command.

23. The electronic device of claim 17, wherein the TLV structure includes data in vCard format.

24. A method for selectively providing information contained in a BER-TLV structure elementary file, comprising:
receiving a RETRIEVE DATA command, the RETRIEVE DATA command identifying a specific portion of a TLV structure in the BER-TLV structure elementary file; and
in response to the RETRIEVE DATA command, returning a content item from the data storage unit based upon the identified specific portion of the TLV structure.

25. The method of claim 24, wherein the specific portion of the TLV structure is identified by a subtag value specific to a category of information within which the content item falls.

26. The method of claim 24, wherein the specific portion of the TLV structure is identified by a XML-tag item, the XML-tag item used to identify a category of information within which the content item falls.

27. The method of claim 24, wherein the specific portion of the TLV structure is identified by a keyword, the keyword used to identify a category of information within which the content item falls.

28. The method of claim 24, wherein the RETRIEVE DATA command includes an indication that all content items falling within a specific category are desired, and wherein all content items falling within the specific category are returned in response to the RETRIEVE DATA command.

29. The method of claim 24, wherein the TLV structure includes data in vCard format.

30. A computer program product, embodied in a computer-readable medium, for selectively providing information contained in a BER-TLV structure elementary file, comprising:
computer code for receiving a RETRIEVE DATA command, the RETRIEVE DATA command identifying a specific portion of a TLV structure; and
computer code for, in response to the RETRIEVE DATA command, returning a content item from the data storage unit based upon the identified specific portion of the TLV structure.

31. The computer program product of claim 30, wherein the specific portion of the TLV structure is identified by a subtag value specific to a category of information within which the content item falls.

32. The computer program product of claim 30, wherein the specific portion of the TLV structure is identified by a XML-tag item, the XML-tag item used to identify a category of information within which the content item falls.

33. The computer program product of claim 30, wherein the specific portion of the TLV structure is identified by a keyword, the keyword used to identify a category of information within which the content item falls.

34. The computer program product of claim 30, wherein the RETRIEVE DATA command includes an indication that all content items falling within a specific category are desired, and wherein all content items falling within the specific category are returned in response to the RETRIEVE DATA command.

35. The computer program product of claim 30, wherein the TLV structure includes data in vCard format.
